(19) United States
(12) Patent Application Publication
(10) Pub. No.: US 2017/0026292 A1
(43) Pub. Date: Jan. 26, 2017

(54) COMMUNICATION LINK FAILURE DETECTION IN A SOFTWARE DEFINED NETWORK

(71) Applicant: Schweitzer Engineering Laboratories, Inc., Pullman, WA (US)

(72) Inventors: Rhett Smith, Kuna, ID (US); Marc Ryan Berner, Monroe, WA (US)

(21) Appl. No.: 14/803,773

(22) Filed: Jul. 20, 2015

(51) Int. Cl. H04L 12/801; H04L 12/26

(52) U.S. Cl. CPC H04L 47/12; H04L 43/16

(57) ABSTRACT

The present disclosure pertains to systems and methods of monitoring communication devices and communication links in a software defined network (SDN). In one embodiment a system may include a data bus and a communication interface in communication with the data bus. The system may further include a communication link monitoring subsystem configured to receive an indication of a status of the communication devices and the communication links over time. The system may associate the status of the communication devices and the communication links over time. The system may determine a deviation from normal parameters based on a current status, and may assess a likelihood of a change in the status based on the deviation from normal parameters. If necessary, a traffic rerouting subsystem configured to reroute data traffic to a failover path based on the likelihood of a change in the status.

### FEDERALLY SPONSORED RESEARCH OR DEVELOPMENT

This invention was made with U.S. Government support under Contract No.: DOE-OE0000678. The U.S. Government may have certain rights in this invention.

### TECHNICAL FIELD

The present disclosure pertains to systems and methods for assessing the health of a communication link in a software defined network (“SDN”). More specifically, but not exclusively, various embodiments consistent with the present disclosure may be configured to analyze selected metrics associated with a communication link to assess a likelihood of a failure, to generate information about the precursors to a failure, and to identify the root cause of a failure.

### BRIEF DESCRIPTION OF THE DRAWINGS

Non-limiting and non-exhaustive embodiments of the disclosure are described, including various embodiments of the disclosure, with reference to the figures, in which:

FIG. 1 illustrates a simplified one-line diagram of an electric power transmission and distribution system in which a plurality of communication devices may facilitate communication in a software defined network consistent with embodiments of the present disclosure.

FIG. 2 illustrates a conceptual representation of an SDN architecture including a control plane, a data plane, and a plurality of data consumers/producer devices that may be deployed in an electric power transmission and distribution system consistent with embodiments of the present disclosure.

FIG. 3 illustrates a flow chart of a method of generating a database of information that may be used to assess a likelihood of a failure, to generate information about the precursors to a failure, and to identify the root cause of a failure consistent with embodiments of the present disclosure.

FIG. 4 illustrates a flowchart of a method for monitoring a communication flow to identify a precursor of a failure and assessing whether to reroute traffic consistent with embodiments of the present disclosure.

FIG. 5 illustrates a flowchart of a method for monitoring reliability metrics of a failover path and generating a new failover path consistent with embodiments of the present disclosure.

FIG. 6 illustrates a functional block diagram of a system configured to assess a likelihood of a failure, to generate information about the precursors to a failure, and to identify the root cause of a failure consistent with embodiments of the present disclosure.

### DETAILED DESCRIPTION

Modern electric power distribution and transmission systems may incorporate a variety of communication technologies that may be used to monitor and protect the system. The communication equipment may be configured and utilized to facilitate an exchange of data among a variety of devices that monitor conditions on the power system and implement control actions to maintain the stability of the power system. The communication networks carry information necessary for the proper assessment of power system conditions and for implementing control actions based on such conditions. In addition, such messages may be subject to time constraints because of the potential for rapid changes in conditions in an electric power transmission and distribution system.

Some electric power transmission and distribution systems may incorporate software defined network (“SDN”) networking technologies that utilize a controller to configure and monitor on the network. SDN networking technologies offer a variety of advantages that are advantageous in electric power systems (e.g., deny-by-default security, better latency control, symmetric transport capabilities, redundancy and fail over planning, etc.).

An SDN allows a programmatic change control platform, which allows an entire communication network to be managed as a single asset, simplifies the understanding of the network, and enables continuous monitoring of a network. In an SDN, the systems that decide where the traffic is sent (i.e., the control plane) are separated from the systems that perform the forwarding of the traffic in the network (i.e., the data plane).

The control plane may be used to achieve the optimal usage of network resources by creating specific data flows through the communication network. A data flow, as the term is used herein, refers to a set of parameters used to match and take action based on network packet contents. Data flows may permit specific paths based on a variety of criteria that offer significant control and precision to operators of the network. In contrast, in large traditional networks, trying to match a network discovered path with an application desired data path may be a challenging task involving changing configurations in many devices. To compound this problem, the management interfaces and feature sets used on many devices are not standardized. Still further, network administrators often need to reconfigure the network to avoid loops, gain route convergence speed, and prioritize a certain class of applications.

Significant complexity in managing a traditional network in the context of an electric power transmission and distribution system arises from the fact that each network device (e.g., a switch or router) has control logic and data forwarding logic integrated together. For example, in a traditional network router, routing protocols such as Routing Information Protocol (RIP) or Open Shortest Path First (OSPF) constitute the control logic that determines how a packet should be forwarded. The paths determined by the routing protocol are encoded in routing tables, which are then used to forward packets. Similarly, in a Layer 2 device such as a network bridge (or network switch), configuration parameters and/or Spanning Tree Algorithm (STA) constitute the control logic that determines the path of the packets. Thus, the control plane in a traditional network is distributed in the switching fabric (network devices), and as a consequence, changing the forwarding behavior of a network involves changing configurations of many (potentially all) network devices.

In an SDN, a controller embodies the control plane and determines how packets (or frames) should flow (or be forwarded) in the network. The controller communicates this information to the network devices, which constitute the data plane, by setting their forwarding tables. This enables centralized configuration and management of a network. As such, the data plane in an SDN consists of relatively simple packet forwarding devices with a communications interface to the controller to receive forwarding information. In addition to simplifying management of a network, an SDN architecture may also enable monitoring and troubleshooting features that may be beneficial for use in an electric power distribution system, including but not limited to: mirroring a data selected flow rather than mirroring a whole port; alarming on bandwidth when it gets close to saturation; providing metrics (e.g., counters and meters for quality of service, packet counts, errors, drops, or overruns, etc.) for a specified flow; permitting monitoring of specified applications rather than monitoring based on VLANs or MAC addresses.

Various embodiments consistent with the present disclosure may utilize various features available in an SDN to monitor a physical and/or logical communication link in the network. As the term is used here, a logical communication link refers to a data communication channel between two or more relationship between communicating hosts in a network. A logical communication link may encompass any number of physical links and forwarding elements used to make a connection between the communicating hosts. The physical links and forwarding elements used to create a specific communication path embodying a logical communication link may be adjusted and changed based on conditions in the network. For example, where an element in a specific communication path fails (e.g., a communication link fails or a forwarding device fails), a failover path may be activated so that the logical communication link is maintained. Information may be gathered by monitoring the physical and/or logical communication link to identify and associate information that may be utilized to assess a likelihood of a failure, to generate information about the precursors to a failure, and to identify the root cause of a failure. Such information may then be used to generate reliable failover paths for data flows within the SDN.

In various embodiments, the centralized nature of an SDN may provide additional information regarding the physical health of network devices and cable connections. A controller in the SDN may receive a variety of metrics from communication devices throughout the network that provide information that may be used to assess the health of the network and to identify problems within the network. As data is transmitted on the network, a variety of parameters may be monitored that provide information about the health of each communication device and communication link in the network. For example, in a system utilizing fiber-optic communication links parameters such as reflective characteristics, attenuation, signal-to-noise ratio, and harmonics can be analyzed to determine conditions in which the fiber optic cable is likely to fail in the near future. An estimate of a likelihood of failure may be based on monitoring the degradation of a monitored communication channel over time and/or information about communication links that share one or more characteristics with the monitored communication channel.

Embodiments consistent with the present disclosure may be utilized in a variety of communication devices. A communication device, as the term is used herein, is any device that is capable of accepting and forwarding data traffic in a data communication network. In addition to the functionality of accepting and forwarding data traffic, communication devices may also perform a wide variety of other functions and may range from simple to complex devices.

The embodiments of the disclosure will be best understood by reference to the drawings, wherein like parts are designated by like numerals throughout. It will be readily understood that the components of the disclosed embodiments, as generally described and illustrated in the figures herein, could be arranged and designed in a wide variety of different configurations. Thus, the following detailed description of the embodiments of the systems and methods of the disclosure is not intended to limit the scope of the disclosure, as claimed, but is merely representative of possible embodiments of the disclosure. In addition, the steps of a method do not necessarily need to be executed in any specific order, or even sequentially, nor need the steps be executed only once, unless otherwise specified.

In some cases, well-known features, structures or operations are not shown or described in detail. Furthermore, the described features, structures, or operations may be combined in any suitable manner in one or more embodiments. It will also be readily understood that the components of the embodiments as generally described and illustrated in the figures herein could be arranged and designed in a wide variety of different configurations.

Several aspects of the embodiments described may be implemented as software modules or components. As used herein, a software module or component may include any type of computer instruction or computer executable code located within a memory device and/or transmitted as electronic signals over a system bus or wired or wireless network. A software module or component may, for instance, comprise one or more physical or logical blocks of computer instructions, which may be organized as a routine, program, object, component, data structure, etc., that performs one or more tasks or implements particular abstract data types.

In certain embodiments, a particular software module or component may comprise disparate instructions stored in different locations of a memory device, which together implement the described functionality of the module. Indeed, a module or component may comprise a single instruction or many instructions, and may be distributed over several different code segments, among different programs, and across several memory devices. Some embodiments may be practiced in a distributed computing environment where tasks are performed by a remote processing device linked through a communications network. In a distributed computing environment, software modules or components may be located in local and/or remote memory storage devices. In addition, data being tied or rendered together in a database record may be resident in the same memory device, or across several memory devices, and may be linked together in fields of a record in a database across a network.

Embodiments may be provided as a computer program product including a non-transitory computer and/or machine-readable medium having stored thereon instructions that may be used to program a computer (or other electronic device) to perform processes described herein. For example, a non-transitory computer-readable medium may store instructions that, when executed by a processor of a computer system, cause the processor to perform certain methods disclosed herein. The non-transitory computer-readable medium may include, but is not limited to, hard drives, floppy diskettes, optical disks, CD-ROMs, DVD-ROMs, ROMs, RAMs, EPROMs, EEPROMs, magnetic or optical cards, solid-state memory devices, or other types of machine-readable media suitable for storing electronic and/or processor executable instructions.

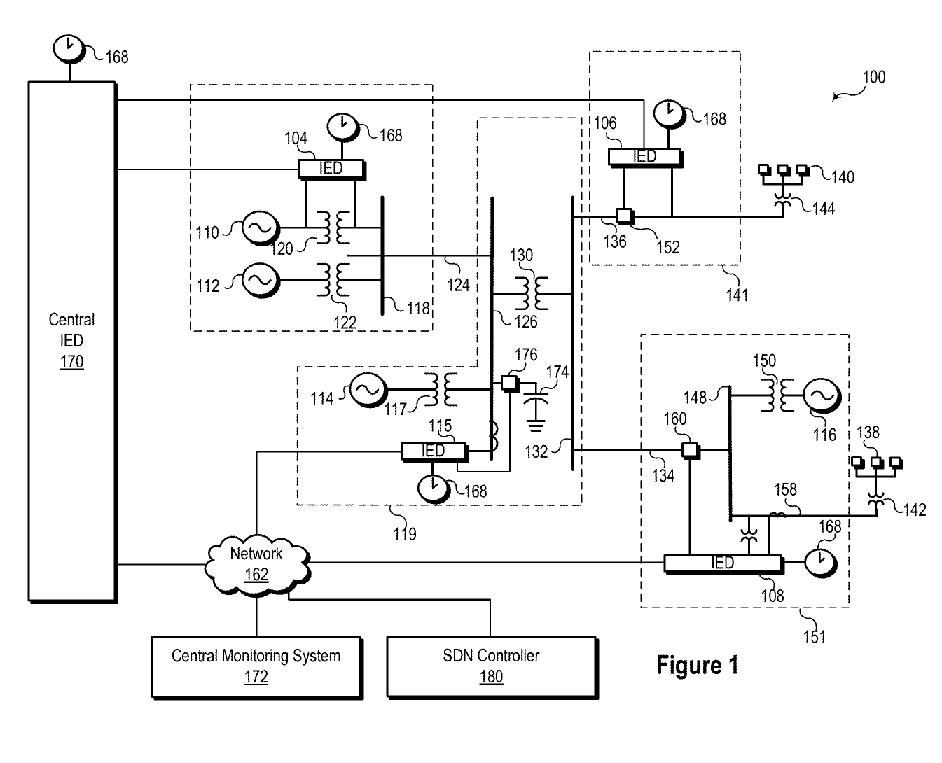

FIG. 1 illustrates an example of an embodiment of a simplified one-line diagram of an electric power transmission and distribution system 100 in which a plurality of communication devices may facilitate communication in a software defined network consistent with embodiments of the present disclosure. Electric power delivery system 100 may be configured to generate, transmit, and distribute electric energy to loads. Electric power delivery systems may include equipment, such as electric generators (e.g., generators 110, 112, 114, and 116), power transformers (e.g., transformers 117, 120, 122, 130, 142, 144 and 150), power transmission and delivery lines (e.g., lines 124, 134, and 158), circuit breakers (e.g., breakers 152, 160, 176), busses (e.g., busses 118, 126, 132, and 148), loads (e.g., loads 140, and 138) and the like. A variety of other types of equipment may also be included in electric power delivery system 100, such as voltage regulators, capacitor banks, and a variety of other types of equipment.

Substation 119 may include a generator 114, which may be a distributed generator, and which may be connected to bus 126 through step-up transformer 117. Bus 126 may be connected to a distribution bus 132 via a step-down transformer 130. Various distribution lines 136 and 134 may be connected to distribution bus 132. Distribution line 136 may lead to substation 141 where the line is monitored and/or controlled using IED 106, which may selectively open and close breaker 152. Load 140 may be fed from distribution line 136. Further step-down transformer 144 in communication with distribution bus 132 via distribution line 136 may be used to step down a voltage for consumption by load 140.

Distribution line 134 may lead to substation 151, and deliver electric power to bus 148. Bus 148 may also receive electric power from distributed generator 116 via transformer 150. Distribution line 158 may deliver electric power from bus 148 to load 138, and may include further step-down transformer 142. Circuit breaker 160 may be used to selectively connect bus 148 to distribution line 134. IED 108 may be used to monitor and/or control circuit breaker 160 as well as distribution line 158.

Electric power delivery system 100 may be monitored, controlled, automated, and/or protected using intelligent electronic devices (IEDs), such as IEDs 104, 106, 108, 115, and 170, and a central monitoring system 172. In general, IEDs in an electric power generation and transmission system may be used for protection, control, automation, and/or monitoring of equipment in the system. For example, IEDs may be used to monitor equipment of many types, including electric transmission lines, electric distribution lines, current transformers, busses, switches, circuit breakers, reclosers, transformers, autotransformers, tap changers, voltage regulators, capacitor banks, generators, motors, pumps, compressors, valves, and a variety of other types of monitored equipment.

As used herein, an IED (such as IEDs 104, 106, 108, 115, and 170) may refer to any microprocessor-based device that monitors, controls, automates, and/or protects monitored equipment within system 100. Such devices may include, for example, remote terminal units, differential relays, distance relays, directional relays, feeder relays, overcurrent relays, voltage regulator controls, voltage relays, breaker failure relays, generator relays, motor relays, automation controllers, bay controllers, meters, recloser controls, communications processors, computing platforms, programmable logic controllers (PLCs), programmable automation controllers, input and output modules, and the like. The term IED may be used to describe an individual IED or a system comprising multiple IEDs.

A common time signal may be distributed throughout system 100. Utilizing a common or universal time source may ensure that IEDs have a synchronized time signal that can be used to generate time synchronized data, such as synchrophasors. In various embodiments, IEDs 104, 106, 108, 115, and 170 may receive a common time signal 168. The time signal may be distributed in system 100 using a communications network 162 or using a common time source, such as a Global Navigation Satellite System (“GNSS”), or the like.

According to various embodiments, central monitoring system 172 may comprise one or more of a variety of types of systems. For example, central monitoring system 172 may include a supervisory control and data acquisition (SCADA) system and/or a wide area control and situational awareness (WACSA) system. A central IED 170 may be in communication with IEDs 104, 106, 108, and 115. IEDs 104, 106, 108 and 115 may be remote from the central IED 170, and may communicate over various media such as a direct communication from IED 106 or over a wide-area communications network 162. According to various embodiments, certain IEDs may be in direct communication with other IEDs (e.g., IED 104 is in direct communication with central IED 170) or may be in communication via a communication network 162 (e.g., IED 108 is in communication with central IED 170 via communication network 162).

Communication via network 162 may be facilitated by networking devices including, but not limited to, multiplexers, routers, hubs, gateways, firewalls, and switches. In some embodiments, IEDs and network devices may comprise physically distinct devices. In other embodiments, IEDs and network devices may be composite devices, or may be configured in a variety of ways to perform overlapping functions. IEDs and network devices may comprise multi-function hardware (e.g., processors, computer-readable storage media, communications interfaces, etc.) that can be utilized in order to perform a variety of tasks that pertain to network communications and/or to operation of equipment within system 100.

An SDN controller 180 may be configured to interface with equipment in network 162 to create an SDN that facilitates communication between IEDs 170, 115, 108, and monitoring system 172. In various embodiments, SDN controller 180 may be configured to interface with a control plane (not shown) in network 162. Using the control plane, controller 180 may be configured to direct the flow of data within network 162.

SDN controller 180 may be configured to receive information from a plurality of devices in network 162 regarding transmission of data. In embodiments in which network 160 includes fiber optic communication links, the data collected by the SDN controller 180 may include reflection characteristics, attenuation characteristics, signal-to-noise ratio characteristics, harmonic characteristics, packet loss statics, and the like. In embodiments in which network 160 includes electrical communication links, the data collected by the SDN controller 180 may include voltage measurements, signal-to-noise ratio characteristics, packet loss statics, and the like. Of course, network 162 may include both electrical and optical transmission media in various embodiments. The information collected by SDN controller 180 may be configured to assess a likelihood of a failure, to generate information about the precursors to a failure, and to identify the root cause of a failure. SDN controller 180 may be configured to associate information regarding the status of various communication devices and communication links to assess a likelihood of a failure. Such associations may be utilized to generate information about the precursors to a failure, and to identify the root cause of a failure consistent with embodiments of the present disclosure.

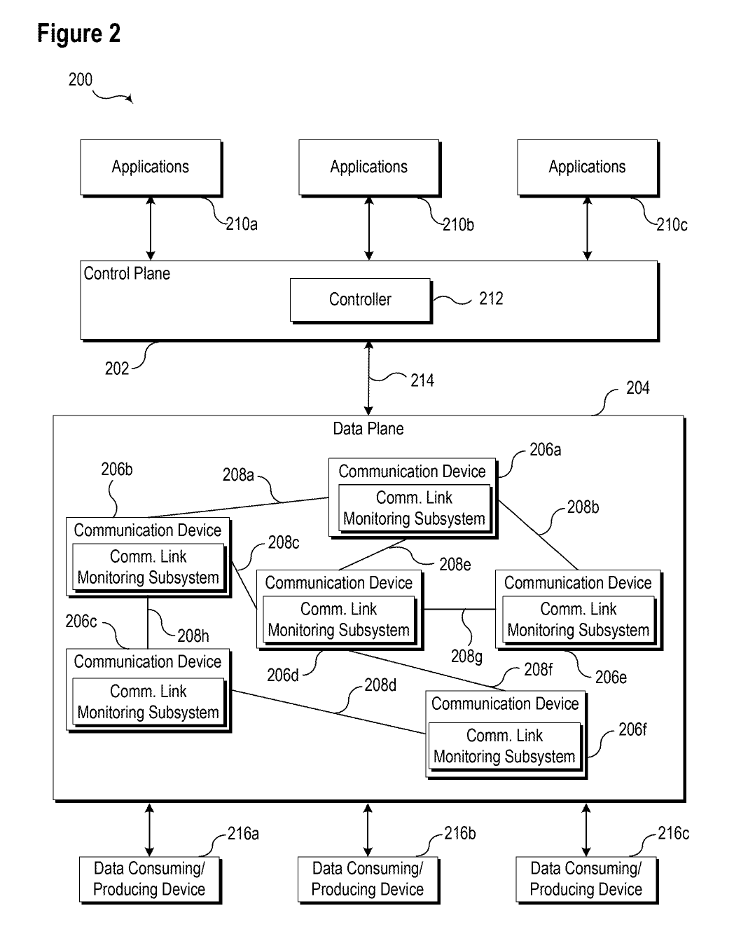

FIG. 2 illustrates a conceptual representation 200 of an SDN architecture including a control plane 202, a data plane 204, and a plurality of data consumers/producer devices 210a-210c that may be deployed in an electric power transmission and distribution system consistent with embodiments of the present disclosure. The control plane 202 directs the flow of data through the data plane 204. More specifically, a controller 212 may communicate with the plurality of communication devices 206a-206f via an interface 214 to establish data flows. The controller may specify rules for routing traffic through the data plane 204 based on a variety of criteria.

As illustrated, the data plane 204 includes a plurality of communication devices 206a-206f in communication with one another via a plurality of physical links 208a-208h. In various embodiments, the communication devices 206a-206f may be embodied as switches, multiplexers, and other types of communication devices. The physical links 208a-208h may be embodied as Ethernet, fiber optic, and other forms of data communication channels. As illustrated, the physical links 208a-208h between the communication devices 206a-206f may provide redundant connections such that a failure of one of the physical links 208a-208h is incapable of completely blocking communication with an affected communication device. In some embodiments, the physical links 208a-208h may provide an N−1 redundancy or better.

The plurality of applications 210a-210c may represent a variety of applications 210a-210c operating in an applications plane. In the SDN architecture illustrated in FIG. 2, controller 212 may expose an application programming interface (API) that services 210a-210c can use to configure the data plane 204. In this scenario, controller 212 may act as an interface to the data plane 204 while the control logic resides in the applications 210a-210c. The configuration of controller 212 and applications 210a-210c may be tailored to meet a wide variety of specific needs.

The data consuming/producing devices 216a-216c may represent a variety of devices within an electric power transmission and distribution system that produce or consume data. For example, data consuming/producing devices may be embodied as a pair of transmission line relays configured to monitor an electrical transmission line. The transmission line relays may monitor various aspects of the electric power flowing through the transmission line (e.g., voltage measurements, current measurements, phase measurements, synchrophasers, etc.) and may communicate the measurements to implement a protection strategy for the transmission line. Traffic between the transmission line relays may be routed through the data plane 204 using a plurality of data flows implemented by controller 212. Of course, data consuming/producing devices 216a-216c may be embodied by a wide range of devices consistent with embodiments of the present disclosure.

The plurality of communication devices 206a-206f may each include a communication link monitoring system that may monitor a plurality of physical links 208a-208h. Various parameters may be monitored for different types of physical links. For example, if a communication link monitoring system is monitoring a fiber optic communication link, the monitoring system may collect information regarding reflection characteristics, attenuation characteristics, signal-to-noise ratio characteristics, harmonic characteristics, packet loss statics, and the like. If a communication link monitoring system is monitoring an electrical communication link, the monitoring system may collect information regarding voltage measurements, signal-to-noise ratio characteristics, packet loss statics, and the like. The information collected by the communication link monitoring systems may be communicated to the controller 212.

Based on the information collected about the physical links 208a-208h, the controller 212 may assess the health of logical communication links between devices in system 200. For example, a logical communication link between device 216a and 216c may be created using a specific path that includes communication devices 206c and 206f and physical link 208d. The controller 212 may receive information about the health of the path created by communication devices 206c and 206f and physical link 208d from the communication link monitoring subsystems in communication devices 206c and 206f. In the event that a problem is detected in the physical link 208d, controller 212 may create a failover communication path. In various embodiments, the failover path may be specified in advance or may be dynamically created based on various criteria (e.g., available bandwidth, latency, shortest path, etc.). In the event that data traffic must be redirected because of a failure of physical link 208d, a failover may be created or activated. The logical communication link may be embodied utilizing a variety of specific paths, with the shortest failover path utilizing communication device 206c, physical link 208h, communication device 206b, physical link 208c, communication device 206d, physical link 208f, and communication device 206f.

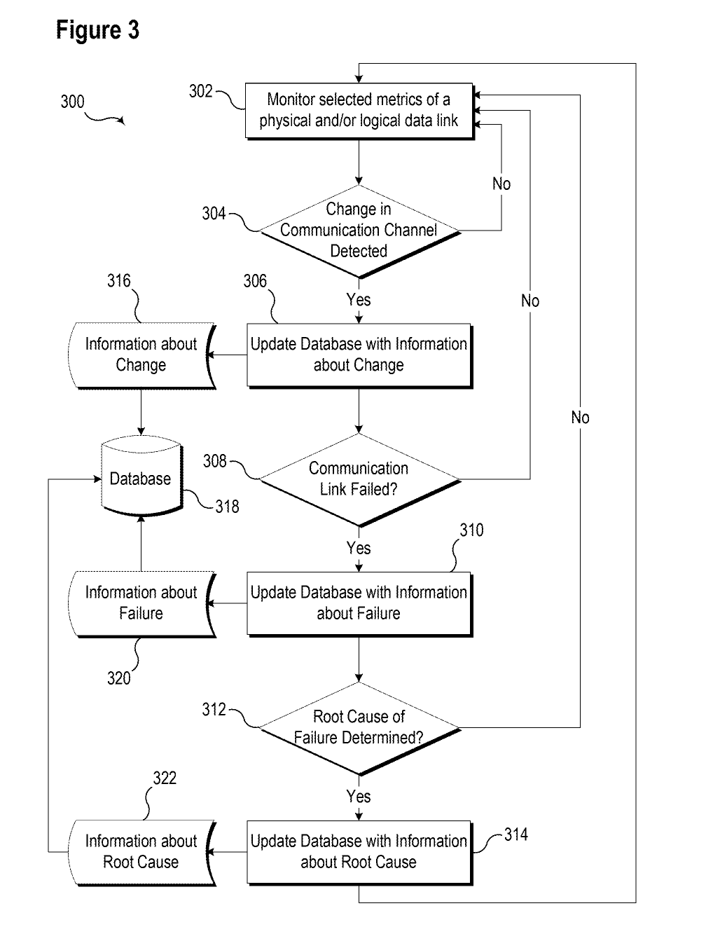

FIG. 3 illustrates a flow chart of a method 300 of generating a database of information that may be used to assess a likelihood of a failure, to generate information about the precursors to a failure, and to identify the root cause of a failure consistent with embodiments of the present disclosure. At 302, a physical and/or logical data link may be monitored, which may continue until a change is detected at 304. At 306, a database 318 may be updated with information about the change 316. Although method 300 refers to generation of a database, a variety of collection and analysis tools may be utilized in connection with embodiments consistent with the present disclosure. For example, certain embodiments may utilize trending algorithms to associate information regarding the historical status of communication devices and communication links with subsequent changes to assess the likelihood of failures in the future.

At 308, method 300 may determine whether the physical and/or logical communication link has failed. If the communication link has not failed, method 300 may return to 302 and continue to monitor the physical and/or logical communication link. If it is determined that the communication link has failed at 308, the database 318 may be updated at 310 with information about the failure 320. Information about the failure may include measurements that occurred before the failure. A system implementing method 300 may, over time, develop metrics for determining when the data attributes are degraded enough because packet lose will start happening, once this value is learned it is applied as a threshold to other links of the same type (e.g., a 100 Mbps link, a 1 Gbps link). Once the method determines that a failure is close, traffic may be rerouted around the failed link without any packet lose and alert the system owners of the failure.

At 312, method 300 may determine whether a root cause of the failure has been determined. The root cause of the failure may be determined without user intervention in cases where sufficient information is available. In other cases, a user may determine the root cause, which may be manually generated and/or entered into database 318. In some embodiments, analysis of the selected metrics of the physical or logical communication link may be sufficient to identify a root cause of the problem because the root cause manifests itself through a predictable pattern that is reflected in the selected metrics. In various embodiments, conditions such as failed or failing crimped cable connections, failed or failing spliced cables, increasingly cloud fiber optic communication media, etc.

In some embodiments, the data could be compiled into an event report that could lead to a root cause analysis. The root cause analysis can be handled in the same way that root cause analysis was performed in the electrical system. If a root cause of failure is determined at 312, the database 318 may be updated at 314 with information about the root cause 322. If a root cause is determined, the information may aid in diagnosing and/or repairing the problem. For example, the root cause analysis may determine that the raw data regarding the changes in the communication channel indicates that the failure is attributable to a splice that has failed or is in the process of failing. Using information about the root cause of the failure, an operator may be better able to correct the problem and avoid reoccurrence of the problem.

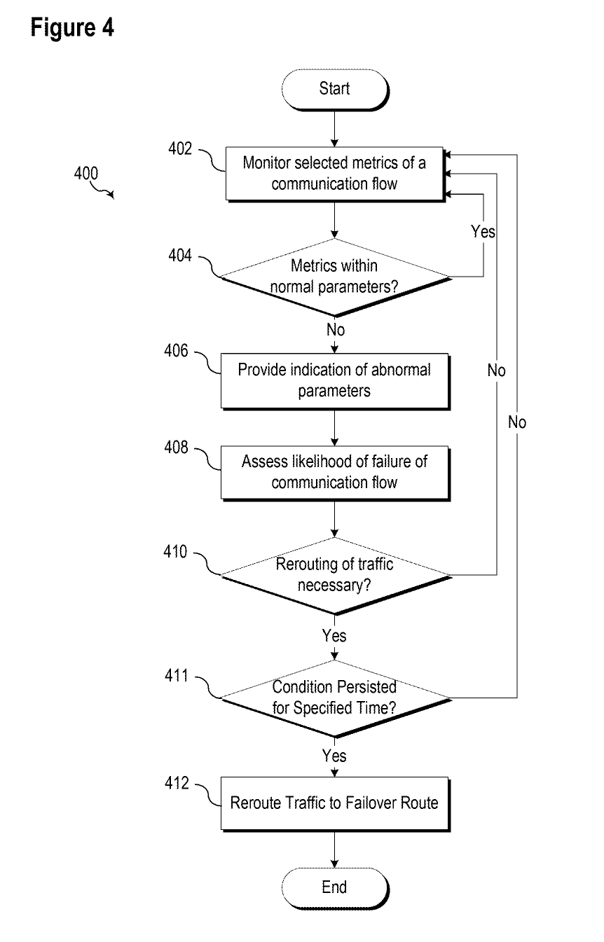

FIG. 4 illustrates a flowchart of a method 400 for monitoring a communication flow to identify a precursor of a failure and assessing whether to reroute traffic consistent with embodiments of the present disclosure. At 402, selected metrics of a communication flow in an SDN may be monitored. The communication flow may involve a variety of communication devices and physical links that are configured to route a data flow through a data plane in an SDN. The metrics may include information such as data packet loss, available bandwidth, latency statistics, physical characteristics of communication links, and the like.

At 404, method 400 may determine whether the metrics monitored of the communication flow are within normal parameters. If the metrics are within normal parameters, method 400 may continue to monitor the selected metrics of the communication flow. Upon a determination that the metrics have deviated from normal parameters, an indication of the deviation from parameters may be provided at 406.

At 408, a likelihood of failure of the monitored communication flow may be assessed. The assessment of the likelihood of failure may be based on information about a correlation between the selected metrics and the likelihood of failure. In various embodiments, the metrics may be monitored over time and compared with similar data flows from locations or different networks. For example, a communication flow may be monitored over time. Over the monitored time, the rate of packet loss may increase as conditions associated with the physical communication devices enabling the communication flow change. In one specific example, a fiber optic communication link may become increasingly cloudy to the point that data packet loss increases.

At 410, method 400 may determine whether it is necessary to reroute traffic as a result of the abnormal parameters. If it is determined that rerouting of traffic is not necessary, method 400 may return to 402. In some embodiments, a system implementing method 400 may require that the condition requiring rerouting of the traffic persists for a specified time before taking action. At 411, method 400 may determine whether the condition has persisted for a specified time. In various embodiments, the amount of time to confirm the link failure may be adjustable. Highly sensitive data may be associated with a fast failover time. While the fast failover time may lower the link lose detection wait times, a temporary disruption in the connection may result in the link failing over more frequently than may be necessary. Further, the failover may also impact other communication links as the failover link is routed through communication devices and communication links in the failover path. In various embodiments, a user may specify a failover time for a specific logical or physical communication link. Allowing a user to specify a failover time may allow the user to balance the importance of the data with disruption to the network resulting from the rerouting of traffic.

If routing of traffic is necessary, at 412, traffic may be rerouted to a failover route. In various embodiments, the failover route may be specified by a user or may be determined without user involvement based on an analysis of available communication paths and performance metrics of the communication network. Continuing the example from the above regarding the fiber optic cable, as data packet loss increases as a result of the cable becoming increasingly cloudy, a system implementing method 400 may determine a point at which the fiber optic communication link is no longer capable of reliable operation and determine that traffic should be rerouted at 410. Other examples of abnormal parameters that may result in data traffic being rerouted include, but are not limited to, power supply performance (voltage, current, and ripple), transmission latency, dropped packets in the communication device, logs showing vectors in the communication device, signal-to-noise strength, and the like.

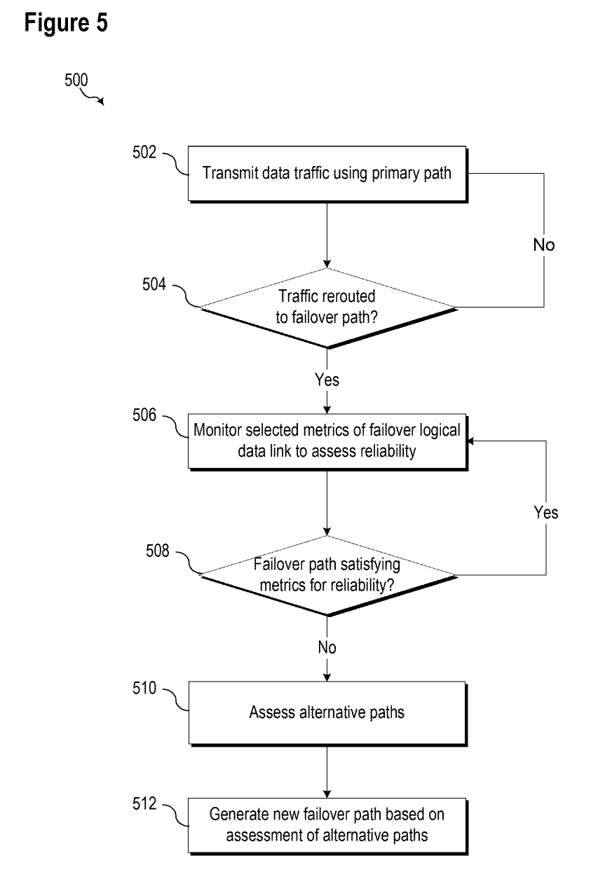

FIG. 5 illustrates a flowchart of a method 500 for monitoring reliability metrics of a failover path and generating a new failover path consistent with embodiments of the present disclosure. At 502, data may be transmitted using a primary path. The primary path may include a plurality of communication devices and physical communication links configured to transmit data in a data communication network. At 504, method 500 may determine whether the traffic has been rerouted to a failover path. When the traffic is rerouted, at 506, selected metrics of the failover path may be monitored.

At 508, method 500 may determine whether the failover path is satisfying metrics for reliability. The metrics for reliability may include various parameters, such as data packet loss, latency, data throughput, available bandwidth, and a variety of other parameters that may be monitored in a data communication network. If the metrics for reliability are satisfied, method 500 may return to 506. If the metrics for reliability are not satisfied, at 510, alternative paths may be assessed. The assessment of alternative paths may involve assessing various parameters associated with communication devices and physical communication links that may be used to create alternative paths. At 512, a new failover path may be generated based on the assessment of alternative paths. In some embodiments, the new failover path may be selected without user action. In other embodiments, a user may be presented with a variety of options and the user may select the new failover path.

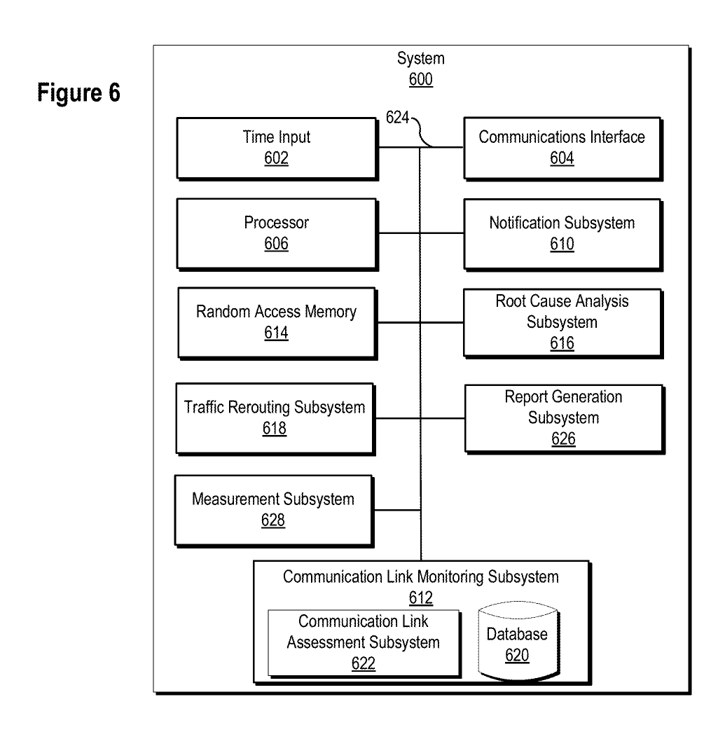

FIG. 6 illustrates a functional block diagram of a system 600 configured to assess a likelihood of a failure, to generate information about the precursors to a failure, and to identify the root cause of a failure consistent with embodiments of the present disclosure. In some embodiments, system 600 may be implemented using hardware, software, firmware, and/or any combination thereof. Moreover, certain components or functions described herein may be associated with other devices or performed by other devices. The specifically illustrated configuration is merely representative of one embodiment consistent with the present disclosure.

System 600 includes a communications interface 604 configured to communicate with other devices (not shown). Communications interface 604 may facilitate communications with multiple devices. System 600 may further include a time input 602, which may be used to receive a time signal (e.g., a common time reference) allowing system 600 to apply a time-stamp received data. In certain embodiments, a common time reference may be received via communications interface 604, and accordingly, a separate time input may not be required. One such embodiment may employ the IEEE 1588 protocol. A data bus 624 may facilitate communication among various components of system 600.

Processor 606 may be configured to process communications received via communications interface 604 and time input 602 and to coordinate the operation of the other components of system 600. Processor 606 may operate using any number of processing rates and architectures. Processor 606 may be configured to perform any of the various algorithms and calculations described herein. Processor 606 may be embodied as a general purpose integrated circuit, an application specific integrated circuit, a field-programmable gate array, and/or any other suitable programmable logic device.

Instructions to be executed by processor 606 may be stored in random access memory 614 (RAM). Such instructions may include information for processing routing and processing data packets received via communications interface 604 based on a plurality of data flows.

A communication link monitoring subsystem 612 may be configured to receive an indication of a status of various communication devices and communication links over time. A communication link assessment subsystem 622 may be configured to determine a deviation from normal parameters based on the status of the communication devices and the communication links. The communication link monitoring subsystem 612 may be configured to generate a database 620 to associate a status of the various communication devices and the various communication links. The communication link monitoring subsystem may assess a likelihood of a change in the status of one or more of the plurality of communication devices and/or the communication links using information from the database 620 and the communication link assessment subsystem 622.

A notification subsystem may be configured to generate a notification of a departure from normal parameters. The notification may alert an operator of system 600 to potential issues so that the operator can take appropriate action. As discussed above, certain actions may be taken without notifying a user. The notification may take a variety of forms and may be customized by a user to provide a desired level of notification. In various embodiments, the notification may include an email message, an SMS text message, a notification by phone, etc.

A root cause analysis subsystem 616 may be configured to automatically identify a root cause of the deviation from normal parameters. The root cause analysis subsystem may be configured to analyze information in database 620 and information provided by communication link assessment subsystem 622 to determine a root cause. Over time, as information regarding the status of devices and disruptions in the network increases, system 600 may identify specific indications in the available data that are associated with specific root causes. Such information may be used to facilitate repair of the issues underlying the disruption and to increase the efficiency with which repairs may be completed. In various embodiments, the root cause may be determined automatically and may be included with a notification sent to an operator of system 600 by notification subsystem 610. The root cause analysis subsystem 616 may further be configured to receive a user-specified root cause in cases where the information stored in the database is insufficient to identify the root cause.

A traffic rerouting subsystem 618 may be configured to reroute data traffic based on the conditions existing in a network and a likelihood of disruption in a physical or logical communication link. In some embodiments, a communication link monitoring system may be configured to assess a likelihood of a change in the operation of the network resulting in disruption of a communication channel. In such embodiments, the traffic rerouting subsystem 618 may be configured to reroute data traffic when the likelihood of the change in the status exceeds a specified threshold. In some embodiments, the traffic rerouting system may be configured to reroute traffic using a failover path specified by an operator. In other embodiments, the failover path may be determined using available information about the network (e.g., available bandwidth on other communication links, latency statistics, etc.). Accordingly, in various embodiments the traffic rerouting subsystem 618 may be configured to to identify, with or without user intervention, a failover path over which data may be sent to maintain a logical connection between two or more communicating hosts when a link failure is detected or determined to be unhealthy.

A report generation subsystem 626 may be configured to generate a report including information that may be used to identify a root cause of a disruption on the network. The report may include a variety of information relating to the status of various communication devices and communication links. The information in the report may be used to perform a root cause analysis.

A measurement subsystem 628 may be configured to measure a variety of parameters associated with communications processed by system 600. For example, in embodiments in which system 600 is configured to communicate via a fiber optic communication line, measurement subsystem 628 may be configured to measure a reflective characteristic of the fiber optic communication line, a signal to noise ratio, and a measurement of a harmonic signal. In other embodiments, the measurement subsystem 628 may be configured to monitor packet loss, a latency, and other metrics relating to data throughput.

While specific embodiments and applications of the disclosure have been illustrated and described, it is to be understood that the disclosure is not limited to the precise configurations and components disclosed herein. Accordingly, many changes may be made to the details of the above-described embodiments without departing from the underlying principles of this disclosure. The scope of the present invention should, therefore, be determined only by the following claims.

What is claimed is:

1. A system configured to monitor a plurality of communication devices connected through a plurality of communication links in a software defined network (SDN), the communication device comprising:
a data bus;
a communication interface in communication with the data bus,
a communication link monitoring subsystem configured to:
receive an indication of a status of the plurality of communication devices and the plurality of communication links at a plurality of times;
associate the indication of the status of the plurality of communication devices and the plurality of communication links at a plurality of times;
determine a deviation from normal parameters of at least one of the plurality of communication devices and the plurality of communication links based on the indication of the status; and
assess a likelihood of a change in the status of at least one of the plurality of communication devices and the plurality of communication links based on the deviation from normal parameters;
a traffic rerouting subsystem configured to reroute data traffic to a first failover path based on the likelihood of a change in the status.

2. The system of claim 1, wherein the traffic rerouting subsystem is configured to reroute data traffic when the likelihood of the change in the status exceeds a specified threshold.

3. The system of claim 1, wherein the plurality of communication links comprises a fiber optic communication line, and the status of the fiber optic communication line comprises a measurement of a reflective characteristic of the fiber optic communication line, a signal to noise ratio, and a measurement of a harmonic signal.

4. The system of claim 1, wherein the status of at least one of the plurality of communication devices comprises at least one of a packet loss counter, a latency measurement, a log comprising vectors in the switch, and a signal-to-noise-ratio.

5. The system of claim 1, wherein the change comprises a failure of one of the plurality of communication links.

6. The system of claim 5, wherein the traffic rerouting subsystem is configured to wait a specified time after the failure of one of the plurality of communication links prior to rerouting data traffic to the first failover path.

7. The system of claim 1, wherein the communication link monitoring subsystem is further configured to generate a database to store the indication of the status of the plurality of communication devices and the plurality of communication links at the plurality of times.

8. The system of claim 1, further comprising a root cause analysis subsystem configured to automatically identify a root cause of the change based on:
the indication of the status of at least one of the plurality of communication devices and the plurality of communication links at a time proximate to the change; and
information about the status of the plurality of communication devices and the plurality of communication links prior to the change.

9. The system of claim 8, wherein the root cause analysis subsystem is further configured to receive a user-specified root cause.

10. The system of claim 1, further comprising a notification subsystem configured to provide a notice of at least one of the deviation from normal parameters and rerouting data traffic to the first failover path

11. The system of claim 1, wherein the traffic rerouting subsystem is further configured to automatically assess a second failover path based on the indication of the status of the plurality of communication devices and the plurality of communication links at the plurality of times.

12. The system of claim 11, wherein the traffic rerouting subsystem is further configured to automatically reroute data traffic to a second failover path if the first failover path fails to satisfy at least one metric for reliability.

13. The system of claim 1, wherein the communication link monitoring subsystem is configured to monitor a logical communication link between two devices in the software defined network; and
the traffic rerouting subsystem is configured to reroute data traffic to the first failover path to maintain the logical communication link between the two devices.

14. A method of monitoring a plurality of communication devices connected through a plurality of communication links in a software defined network (SDN), the method comprising:
receiving an indication of a status of the plurality of communication devices and the plurality of communication links at a plurality of times;
associating the indication of the status of the plurality of communication devices and the plurality of communication links at a plurality of times;
determining a deviation from normal parameters of at least one of the plurality of communication devices and the plurality of communication links based on the indication of the status; and
assessing a likelihood of a change in the status of at least one of the plurality of communication devices and the plurality of communication links based on the deviation from normal parameters;
rerouting data traffic to a first failover path based on the likelihood of a change in the status.

15. The method of claim 14, wherein associating the indication of the status of the plurality of communication devices and the plurality of communication links at the plurality of times comprises:
identifying a change in the status of at least one the plurality of communication devices and the plurality of communication links;
storing information about the change;
detecting a failure of at least one of the plurality of communication devices and the plurality of communication links;
storing information about the failure;
determining a root cause of one of the change and the failure; and
storing information about the root cause.

16. The method of claim 14, wherein the change comprises a failure of one of the plurality of communication links.

17. The method of claim 16, further comprising waiting a specified time after the failure of one of the plurality of communication links prior to rerouting data traffic to the first failover path.

18. The method of claim 17, further comprising:
identifying a root cause of the change based on the indication of the status of at least one of the plurality of communication devices and the plurality of communication links at a time proximate to the change and based on information about the status of the plurality of communication devices and the plurality of communication links prior to the change.

19. The method of claim 18, further comprising notifying an operator of the root cause to facilitate repair of a condition that resulted in the deviation from normal parameters.

20. The method of claim 14, further comprising providing a notice of at least one of the deviation from normal parameters and rerouting data traffic to the first failover path to an operator.

21. The method of claim 14, further comprising automatically assessing alternative paths and to automatically generating a new failover path.
